(19) United States
(12) Patent Application Publication
(10) Pub. No.: US 2008/0060298 A1
(43) Pub. Date: Mar. 13, 2008

(54) High Ductility, Shear-Controlled Rods for Concrete Reinforcement

(75) Inventors: Atef Amil Fahmy Fahim, Ontario (CA); Michael Brian Munro, Ontario (CA); Kristian Andrew James Ewen, Ontario (CA)

Correspondence Address: GREER, BURNS & CRAIN, 300 S WACKER DR, 25TH FLOOR, CHICAGO, IL, 60606, US

(73) Assignee: UNIVERSITY OF OTTAWA, Ottawa, Ontario (CA)

(21) Appl. No.: 10/574,864

(22) PCT Filed: Oct. 5, 2004
(86) PCT No.: PCT/CA04/01797

§ 371 Date: Aug. 20, 2007

(30) Foreign Application Priority Data
Oct. 6, 2003 (CA) 2444408

(51) Int. Cl. E04C 5/07; B29C 70/06

(52) U.S. Cl. 52/309.14; 264/211.12; 52/649.1

(57) ABSTRACT

A re-bar (reinforcing rod) for concrete comprises an inner rod of a first material, and an over-wrap of a second material. The over-wrap may be structurally or functionally discontinuous relative to the inner rod.

The present invention relates to the field of concrete reinforcement, and in particular provides pseudo-ductile polymer-based (monolithic polymer or Fibre Reinforced Polymer, FRP) re-bar rods of several novel designs. Each utilizes controlled and predictable interfacial friction during the relative sliding of elements of the re-bar as a means to induce pseudo-ductile behaviour in the re-bar.

Traditionally, the material of choice to reinforce concrete has been steel, in the form of rigid re-bar rods, flexible grids, wire, or pre- or post-tensioned wires and cables.

Steel reinforced concrete is a composite material that combines the positive attributes of both constituents, steel and concrete, and results in a composite that is superior to both. Concrete is an anisotropic material that has the quality of low cost (production and transportation cost) and a very high compressive load carrying capacity. Its ultimate compressive strength ranges between 40 MPa for general use concrete to about 90 MPa for high strength concrete. Under controlled lab environments even higher strength may be achieved. The major drawback of concrete is its very low tensile load carrying capacity. The tensile strength of concrete is only about 10% of its compressive strength. In order to counteract this drawback, steel reinforcing members capable of carrying high tensile loads, generally in the form of re-bar rods, are inserted along the tension side of a concrete member. In order to increase the bond strength between the steel rods and the concrete, the rods are manufactured with a high surface roughness, the most common being in the form of spaced rings or spiralling protrusions along their length.

The tensile strength (yield) of steel is about 10 times that of concrete (ultimate strength). As a result the amount of steel reinforcement required along the tension side of concrete members is not great, and the cost of that reinforcement is an insignificant fraction of the total cost of a project. Steel's most important characteristic as a reinforcement material is its purely plastic behaviour beyond the yield point. Between this point and failure, elongation of up to 40% at a relatively constant stress level provides its high-ductility. This behaviour produces very noticeable cracks in concrete structures as they begin to fail and is an essential life saving characteristic; the early warning allows for evacuation of the structure before complete failure.

Steel, however, has the major drawback of susceptibility to rust particularly in salty or chemically lathed environments. Sea shore structures, and those in cities where salt or chemicals are used to deal with ice and snow accumulation on roads, bridges and garages are typical structures that suffer from such a problem. The cost of repairs of rusted reinforcement in concrete structures is very high and repairs are quite disruptive. As an alternative to steel, polymer-based solutions have been considered. One possible solution is to use a monolithic polymer rod whose elastic modulus and yield strength match that of steel. At present there are no polymers that have achieved these values in rod similar in diameter to that of existing steel rebars. There are continuing improvements in the mechanical properties of such large diameter rods (recently the elastic modulus of polyethylene rods has increased form 1.0 to 20 GPa as a result of new processing techniques). It is quite conceivable that additional changes in processing could increase the elastic modulus of polymeric rods to match that of steel, i.e., 200 GPa. In the meantime major research efforts have identified Fibre Reinforced Polymers (FRP) as candidate materials for re-bars. At present, carbon, aramid, and glass fibres are typically used to reinforce a polymer matrix to form the re-bars.

One of the major advantages of using fibre composites as material for components is. their design flexibility. In the most general sense this means that a designer may take advantage of the high strength, high modulus reinforcing fibres by aligning them in the matrix along the principal stress directions. Since re-bars in concrete are located to take primarily tensile load, fibres in FRP re-bars are aligned along the single principal stress direction, the longitudinal axis, of the re-bar.

While FRP re-bars can match the strength, modulus, and concrete/re-bar bonding requirements, however, they suffer from a lack of ductility (% elongation at failure). This would also be true for the monolithic polymer rods described previously.

Due to the absence of FRP re-bars with adequate ductility, one new approach by others for the design of concrete structures is being developed. In this approach, the FRP re-bars which are the tensile force carriers are over-designed by applying an excessively large factor of safety to the ultimate strength and changing the initial failure criterion to concrete crushing in the compressive region. This approach is costly, and accordingly, an aim of the present invention is to develop FRP re-bars with mechanical properties that are similar to those of traditional steel re-bars. In this case the design approach (and codes) would not need to be changed.

Several research publications and patents dealing with FRP re-bar ductility issues have appeared over the past few years. The most common approach used to produce high “ductility” FRP re-bars whose stress-strain behaviour matches that of steel is to manufacture a hybrid FRP rod using several types of fibre with varying strength and strain to failure values.

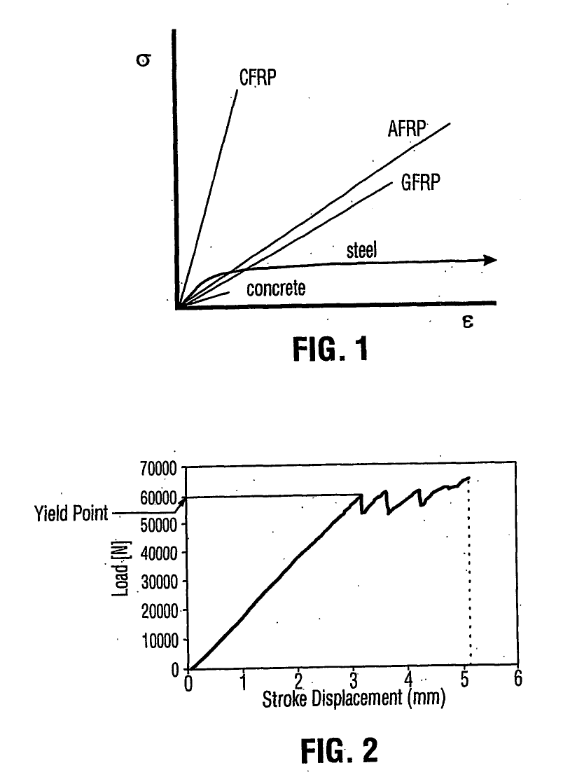

The first such endeavour is attributed to Bunsell and Harris where in their 1974 publication “Hybrid Carbon and Glass Fibre Composites” they demonstrated “pseudo ductility” characteristics for a hybrid bar made of alternating laminates of glass and carbon fibres. In general, hybrid FRP re-bars are currently made using three types of fibre. Carbon fibres are almost always used to provide the elastic modulus equal to that of steel. E-Glass fibres are commonly used to provide the ductility. Aramid fibres, such as Kevlar, are also used as a third fibre type that has a modulus in-between the moduli of carbon and glass and a strain to failure greater than that of glass fibres. As a hybrid re-bar is loaded, the carbon fibres fail first between 0.2 and 2% strain, the load is transferred to the glass fibres which eventually fail at about 2.4% strain, where upon the load is transferred to the aramid fibres and results in a total strain to failure of the FRP re-bar of about 3.5%. The characteristics of these fibres together with those of steel and concrete in tension are shown in FIG. 1. Appropriate amounts of the different fibres are used in the composite re-bar so as to achieve the required strength, modulus, and relatively constant stress up to failure. Unfortunately, the maximum ductility is limited to the highest ultimate failure strain of the selected fibres, typically 3.5%. A typical stress-strain plot of hybrid re-bars reported in De la Rosa, César, “Length Effect in Hybrid FRP Re-bars for Reinforced Concrete Applications”, M. Eng. Thesis, Mechanical Engineering, University of Ottawa, August 2002, is shown in FIG. 2. This approach was initially proposed in 1996 by Arumugasaamy and Greenwood and patented in 1998, U.S. Pat. No. 5,727,357. Several researchers have investigated this approach since then, including Manis, P. A., “Manufacture -and performance evaluation of FRP re-bar featuring ductility”, M.S. Thesis, University of Missouri-Rolla, 1998, 77 pages; Somboonsong, W., Ko, F. K., and Harris H. G., “Ductile Hybrid Fibre Reinforced Plastic Reinforcing Bar for Concrete Structures: Design Methodology”, ACI Materials Journals, V95, No. 6, 1998 655-666.

A second approach for high-ductility FRP rebars was that proposed by U.S. Pat. No. 6,071,613 (Rieder et al) among others. Their approaches were to increase the toughness of the concrete itself (without re-bars) by using short, discontinuous, randomly oriented fibres to control the behaviour at crack openings.

A further approach involves orienting continuous fibres at an angle to the longitudinal axis of the re-bar. The fibres can be oriented at an angle to the longitudinal axis of the re-bar by processes, such as 2D braiding and filament winding, see, eg. Somboonsong (above); Belardi Ai, Chandrashekara K., Watkings, S. E., “Performance Evaluation of Fibre Reinforced Polymer Reinforcing Bar Featuring Ductility and Health Monitoring Capability”; and Belbardi A., Watkings, S. E., Chandrashekara, K., Corra, J., Konz, B. “Smart fibre-reinforced polymer rods featuring improved ductility and health monitoring capabilities”, Smart Materials and Structures Vol. 10, 2001, 427-431. For these designs ductility is achieved by the re-orientation of the angled fibres under load. This approach was proved to be unsuccessful as the maximum failure strain achieved was 2.1% due to the limited change in the length as the fibres are re-oriented.

Edwards and D'hooghe in Canadian Patent No. 2,396,808 proposes the use of composite material where the matrix is thermoplastic-in order to take advantage of the its flexibility, particularly as it is heated. In one of its embodiments they propose the use of short fibres in the thermoplastic matrix as the core of their re-bar.

The use of short fibres is also done in traditional fibre composites in which increased toughness and ductility is achieved by the pullout of the short fibres from a matrix. The frictional shear stress that exists between the fibres and the matrix can support a tensile load at the same time. In theory this approach would lead to ductilities of up to 50% if the pullout mechanism was equally distributed along the length of the FRP re-bar. However, it is extremely difficult to ensure uniform alignment, uniform bonding, uniform spacing, etc. at the micro-structural level. In addition, there is a very wide range of ultimate tensile strengths of the fibres as found in any high strength, brittle materials. Because of this lack of uniformity, a failure initiates at a local non-uniform point and failure propagates from this point. Increased ductility is achieved only in that small local region.

It is understood that the concept of the pullout of fibres can be successful in increasing ductility if pullout can occur uniformly. This requires that the reinforcing elements have uniform strengths, bond strengths during pullout, uniform alignment, uniform spacing, etc. The Applicants have discovered that uniform strength during pullout can be achieved by ensuring that the frictional shear stress between sliding elements is controlled. This sliding may occur between individual dowels (meso-rods) and matrix or between an inner rod and an over-wrap. It is essential that the sliding occur along the length of the re-bar. For re-bar made with discontinuous meso-rods in a polymer matrix, this requires uniform reinforcement (at each cross-section) along the length of the re-bar. The length of the meso-rods must also be less than a critical length, L_{c}_{ₘ} otherwise tensile failure of the meso-rod will occur rather than the sliding at the interface.

$${L}_{{c}_{m}} = \frac{{σ}_{um} {r}_{m}}{{τ}_{m}} \qquad ( 1 )$$

where L_{c}_{ₘ} is the critical length of the meso-rod
σᵤₘ is the ultimate tensile strength of the meso-rod
rₘ is the radius of the meso-rod, and
τₘ is the frictional shear stress between a meso-rod and the surrounding matrix
   For the over-wrap case, sliding can be achieved by having the over-wrap discontinuous with the discontinuous lengths less than the critical length for the inner rod/over-wrap system:

$${L}_{{c}_{o}} = \frac{{σ}_{ur} {r}_{r}}{{τ}_{r}} \qquad ( 2 )$$

where L_{c}_{ₒ} is the critical length of the over-wrap
σᵤᵣ is the ultimate tensile strength of the inner rod, and
τᵣ is the frictional shear stress between the inner rod and the over-wrap.

In one broad aspect the present invention relates to a reinforcing rod comprising an inner rod of a first material, and an outer over-wrap of a second material, said over-wrap being structurally discontinuous relative to said inner rod.

The inner rod can be made from a monolithic polymeric material or a fibre composite material consisting of fibres and a polymeric matrix. The outer layer is preferably an over-wrap of a fibrous material set in a polymeric resin matrix. The fibrous material is selected from the group consisting of ceramic materials including carbon fibres, glass fibres, particularly E-glass fibres and the group of polymeric fibres, such as aramid fibres and polyethylene fibres. Metallic fibres may also be used. The resin may be selected from the group of thermosetting resins such as epoxies, polyesters, and vinyl esters, and vinyl esters and/or thermoplastic resins, such as nylon or polyethylene and polypropylene.

The structural discontinuity of the over-wrap is defined by zones of weakness separating full strength lengths of the over-wrap. That is, the zones of weakness may be formed by mechanically removing a portion of the second layer after it has been applied to the inner rod. However, the zones of weakness may be achieved by short, spaced apart lengths of said inner rod having no over wrap over same.

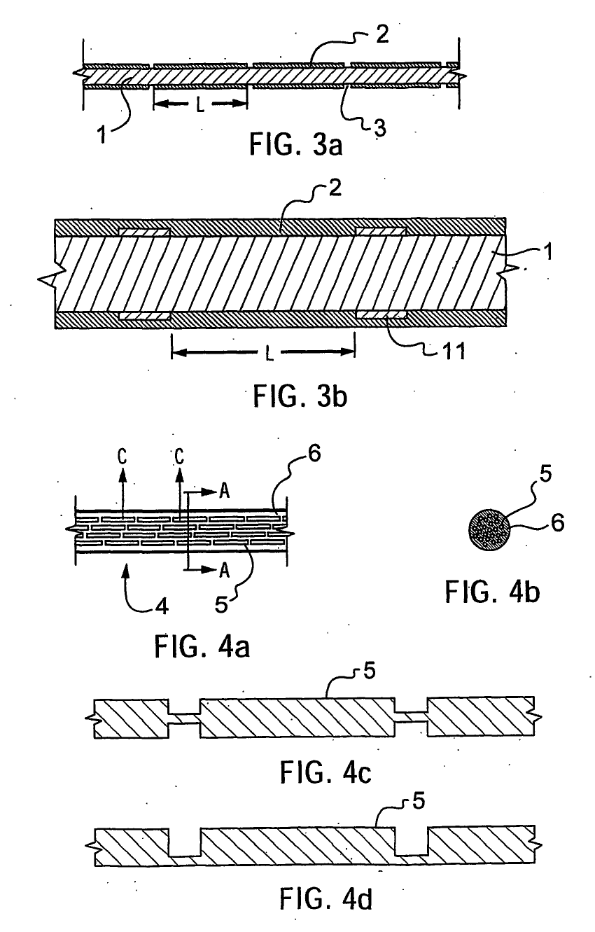

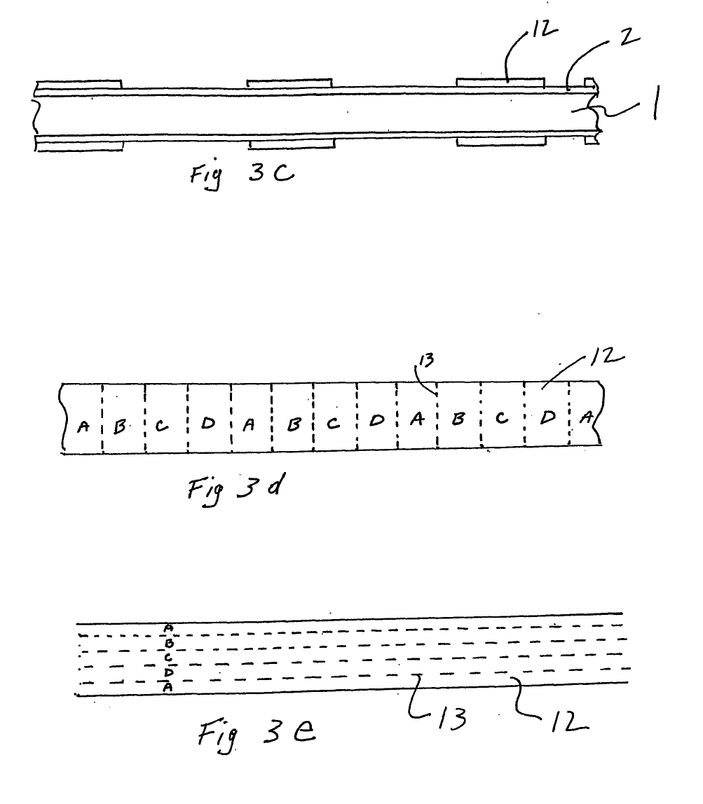

A zone of weakness may also be introduced in a continuos over-wrap using annular sections of a low coefficient of friction material (for example, polytetraflouroethylene) that is placed around the inner rod at various points along the inner rod (FIG. 3b). At any cross-section of the re-bar, the tensile load is being carried by the inner rod (in tension) and the over-wrap in shear at the interface between the over-wrap and the inner rod. Since minimal shear load transfer will occur in the portions with the low friction material, the load normally carried in shear at the interface will be transferred to the over-wrap as an increased tensile load. This will result in tensile failure of the over-wrap, i.e., a zone of weakness.

In a preferred embodiment, the inner rod is a cylinder having radius rᵣ and an ultimate tensile strength σᵤᵣ. The frictional shear stress after original bond failure between the inner rod and the over-wrap is τᵣ, and the over-wrap is comprised of structurally discontinuous portions having a maximum length L_{c}_{ₒ}, wherein

$${L}_{{c}_{o}} \leq \frac{{σ}_{ur} {r}_{r}}{{τ}_{r}} \qquad ( 3 )$$

Preferably, said radius r is in the range of 1-30 mm and said length L_{c}_{ₒ} is in the range of 1-150 cm.

More preferably, radius r is in the range of 3-8 mm.

More preferably, radius r is in the range of 4 -6 mm.

Optimally, radius r is in the range of 4 -5 mm.

A functionally determined radius r is 4.5 mm.

The length L_{c}_{ₒ} may be in the range of 10-20 cm.

Moreover, length L_{c}_{ₒ} is preferably in the range of 12-18 cm.

A functionally determined length L_{c}_{ₒ} is about 15 cm.

In another broad aspect, the present invention relates to a method of inducing pseudo-ductility in a fibre reinforced composite inner rod, said inner rod comprising a solid core and a fibre reinforced polymeric resin over-wrap on said core, said method comprising structurally interrupting said over-wrap at spaced apart locations. The over-wrap may be applied as a resin impregnated fibre braid.

A reinforcing rod comprising a composite rod having an inner core and an outer surface, said outer surface being textured over a predetermined portion thereof to mechanically grip a concrete matrix in which a said rod is embedded.

The over-wrap may be applied as a resin impregnated fibre yarn, unidirectional tape or woven fabric tape helically wound on said core.

Advantageously, the over-wrap is structurally interrupted by being cut in spaced apart annular rings or a continuous helical pattern.

The method of the present invention comprises the steps of i) providing an inner rod comprising solid core of a monolithic polymer or a fibre reinforced polymer; ii) applying bands of material having low frictional shear stress at spaced apart locations on said solid core; iii) applying a fibre reinforced polymeric resin over-wrap over the banded core, whereby said bands of low frictional shear stress material structurally separate zones of over-wrap bonded to said core.

In the method of the present invention, the inner rod is preferably a cylindrical rod having radius rᵣ and an ultimate tensile strength σᵤᵣ, the frictional shear stress after bond failure between the inner rod and the over-wrap is τᵣ, and said over-wrap is comprised of structurally discontinuous portions having a maximum length L_{c}_{ₒ}, wherein

$${L}_{{c}_{o}} = \frac{{σ}_{ur} {r}_{r}}{{τ}_{r}}$$

In an advantageous embodiment, the re-bar comprises at least three materials, at least two of which are present in structurally discontinuous lengths. The composite may comprise a polymer matrix having embedded therein structurally discrete meso-rods of length L_{c}_{ₘ} with radius rₘ, ultimate and tensile strength σᵤₘ, the frictional shear strength between a meso-rod and the polymer matrix being represented by τₘ, wherein

$${L}_{{c}_{m}} \leq \frac{{σ}_{um} {r}_{m}}{{τ}_{m}} \qquad ( 4 )$$

Moreover, the structurally discrete meso-rods preferably comprise a plurality of meso-rods each with a radius less than half that of the composite rod. The structurally discrete dowels may comprise a plurality of elongate meso-rods breakable by a tensile load substantially less than the ultimate tensile strength of each meso-rod, at predetermined weakened locations along the dowels.

It will be understood that the ends of the discrete meso-rods, or the predetermined weakened points in the elongate meso-rods will be randomly distributed, so that several meso-rods do not end at the same point, which would lead to a weak, relatively unreinforced area of matrix.

L_{c}_{ₘ} is preferably in the range of 5-30 cm.

L_{c}_{ₘ} is more preferably in the range of 5-25 cm.

L_{c}_{ₘ} is even more preferably in the range of 8-20 cm.

L_{c}_{ₘ} is yet more preferably in the range of 10-15 cm.

L_{c}_{ₘ} is most preferably in the range of 11-13 cm.

L_{c}_{ₘ} is optimally about 12 cm.

rₘ is preferably in the range of 0.5-4.0 mm.

rₘ is more preferably in the range of 0.5-3.0 mm.

rₘ is even more preferably in the range of 1.0-3.0 mm.

rₘ is most preferably in the range of 1.5-2.5 mm.

rₘ is optimally about 2.0 mm.

### The meso-rods may be made from a material selected from the group consisting of ceramic materials including carbon fibres and glass fibres.

The polymer matrix may be selected from the group consisting of thermoset resins including epoxies, polyesters, and vinyl esters, and, thermoplastic resins including nylons, polyethylene, and polypropylene.

The reinforcing rod of the present invention that comprises meso-rods embedded in a polymer matrix has also got significant utility as a structural member, especially for applications under tension.

In drawings which illustrate the present invention by way of example:

FIG. 1 is a typical tensile stress-strain curves for steel and fibre composites;

FIG. 2 is a typical load-displacement curve of a prior art hybrid FRP re-bar;

FIG. 3a is a side cross-sectional view of a first construction of a first embodiment of the present invention.

FIG. 3b is a side cross-sectional enlarged view of a second construction of the first embodiment of the present invention;

FIG. 3c is a side cross-section enlarged view of a third construction of the first embodiment of the present invention;

FIG. 3d is an external side view of the construction of FIG. 3c, in a commercially practical form;

FIG. 3e is an external side view of the construction of FIG. 3c is an alternate commercially practical form;

FIGS. 4a and 4b are longitudinal and transverse schematic cross-sectional views, respectively of a meso-rod composite re-bar according to a second embodiment of the present invention; and FIGS. 4c and 4d are detail cross sections through line c-c in FIG. 4a of two preferred embodiments of meso-rod construction;

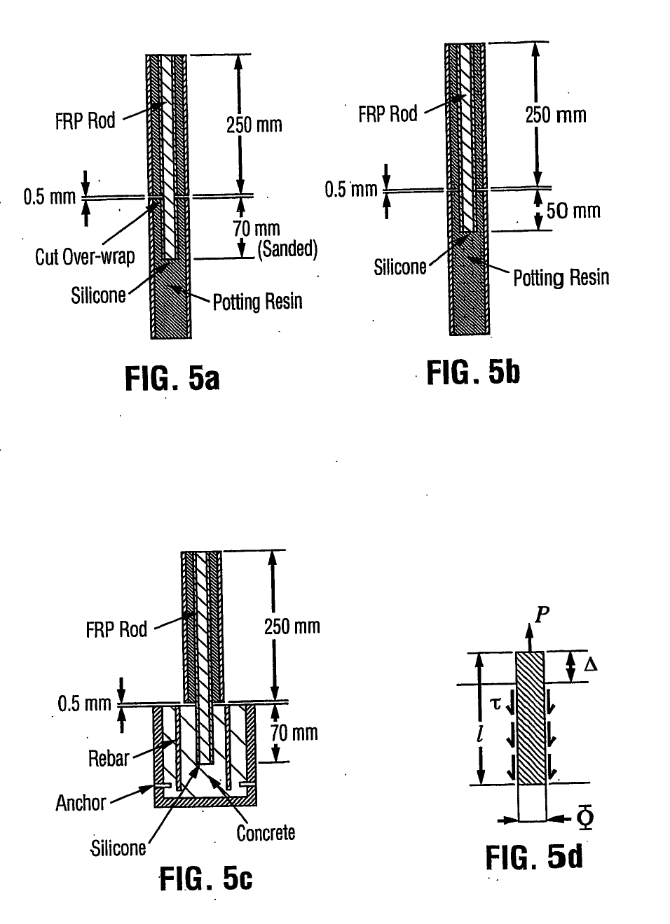

FIGS. 5a, 5b, and 5c, respectively are schematics of a inner rod/over-wrap pull-out test, over-wrap/potting resin pull-out test and over-wrap/concrete pull-out test;

FIG. 5d is the schematic of a typical pull-out test;

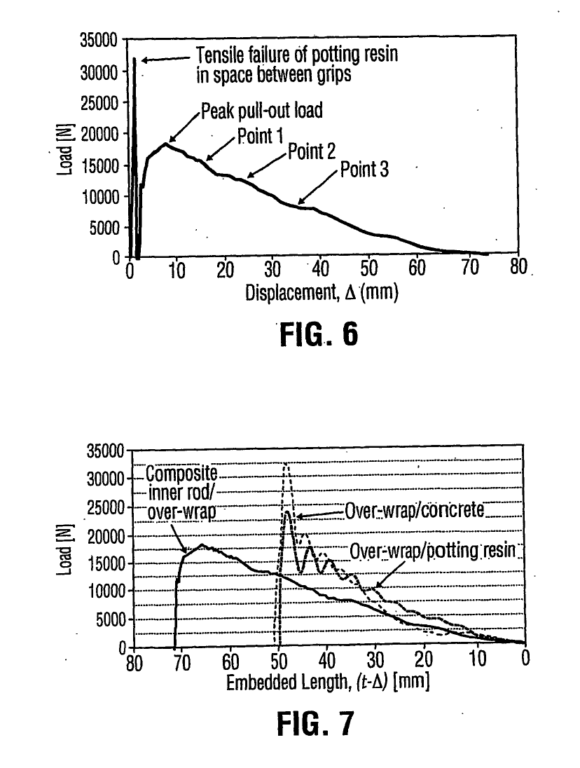

FIG. 6 is a load-displacement curve for the inner rod/over-wrap pull-out test shown schematically in FIG. 4a;

FIG. 7 are frictional load-displacement curves for the three tests shown schematically in FIG. 4a, 4b and 4c;

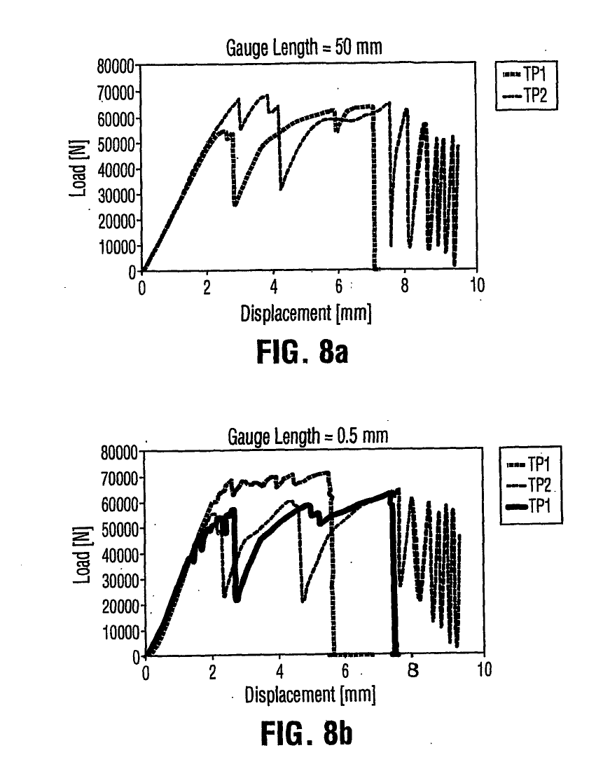

FIGS. 8a and 8b are two schematics of failure mechanisms;

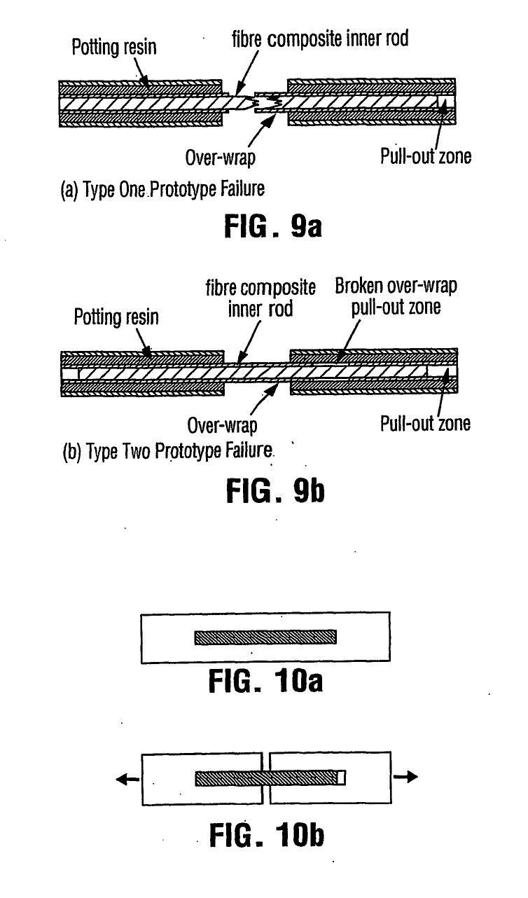

FIGS. 9a and 9b are load-displacement plots for examples embodying the present invention to a lesser and greater extent;

FIGS. 10a and 10b are side cross-sectional schematic views of a single meso-rod and a meso-rod pull-out test;

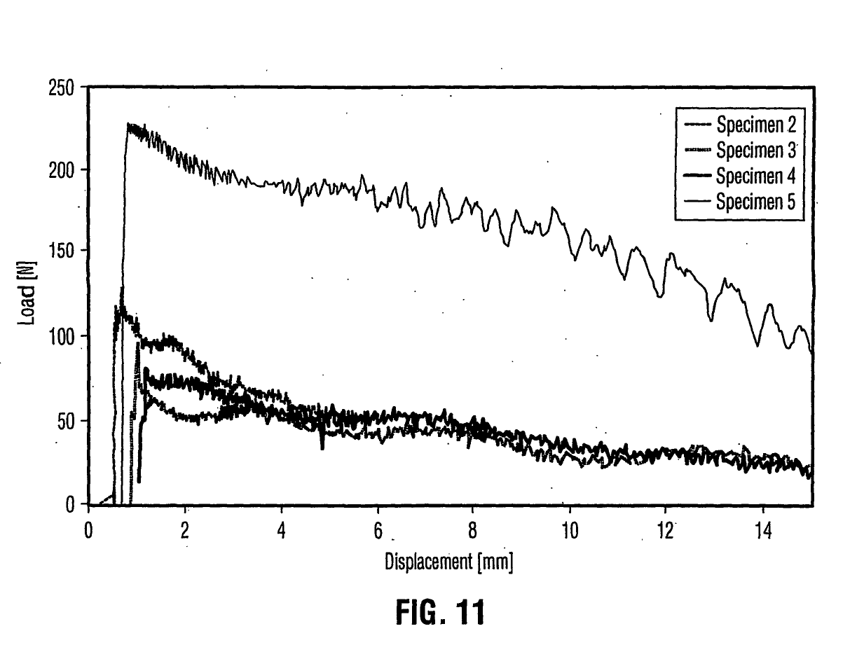

FIG. 11 load displacement curves for three meso-rod specimens.

Referring now to FIGS. 5a to 5d, in preparatory investigations leading to the development of the present invention, for a specific set of manufacturing parameters and materials, the interfacial frictional shear stress after original bond failure of the inner rod/over-wrap interface was estimated to be approximately 10 MPa. As part of a failure investigation undertaken, the interfacial frictional shear stress after original bond failure of all of the appropriate interfaces for the chosen manufacturing parameters, materials, and surface preparation, were determined. FIG. 5d shows a schematic of a typical pullout test. The dimensions for the specific pull-out tests between the over-wrap and the inner rod, the over-wrap and the potting resin, over-wrap and concrete are shown respectively in FIGS. 5a, 5b, and 5c. As shown in FIG. 5a, the over-wrap was cut and the outer surface of the over-wrap was abraded to ensure the proper interface failure. The end of the rod was coated with a silicone release agent to remove that contribution from the load measurement. The load-displacement curve is given in FIG. 6. After initial bond failure along the embedded length, the load due to friction at the interface decreases as the embedded length decreases. With reference to FIG. 5d, the interfacial frictional shear stress is calculated using the following relationship:

$$τ = \frac{P}{π φ ( l - Δ )} \qquad ( 6 )$$

Where (l-Δ) is the embedded length.

Appropriate embedded lengths were selected in order to obtain the desired failure during pullout. The frictional sliding part of the load-displacement curves (based on the dimensions given in FIGS. 5a, 5b and 5c for the inner rod/over-wrap interface, over-wrap/potting resin interface, and over-wrap/concrete interface are given in FIG. 7 for comparison purposes. An average frictional shear stress for the inner rod/over-wrap interface of 9.6 MPa was determined. The frictional interface stress of the over-wrap to potting resin interface was found to be 7.4 MPa. The final interface was that between the over-wrap and concrete. For this interface the average shear stress was found to be 6.8 MPa. The ordering of the magnitudes of the tensile loads due to the frictional shear stresses is correct in that the over-wrap to concrete and the over-wrap to potting resin stresses are greater than for the inner rod to the over-wrap. These values confirmed the typical failure modes of over-wrapped FRP re-bars as well as the potting length of grips specified for testing of FRP re-bars.

According to a first embodiment of the present invention, fibre composite re-bars were designed, fabricated and tested in order to validate the proposed novel pseudo-ductile FRP re-bar. One variant of these prototypes is shown in FIG. 3a.

The selection of materials for the inner rod 1 and over-wrap 2 is a matter of choice for one skilled in the art, given the teaching of the present invention. However, the inner rod will generally be selected from carbon fibre/polymer matrix composite, glass fibre/polymer matrix composite, or aramid fibre/polymer matrix composite or monolithic polymer. The fibre over-wrap 2 will generally be of the same choice of materials as the inner rod. The polymer matrix could be a thermosetting polymer such as epoxy resin, polyester resin or vinyl ester resin or a thermoplastic resin such as nylon, polyethylene or polypropylene. The monolithic polymer would typically be a thermoplastic polymer. The over-wrap is removed for instance by mechanical cutting (or simply by not having been applied) at spaced apart locations 3 separated by length L. Calculation of L is explained below.

One major issue related to the tensile testing of the re-bars was the choice of gauge length of the specimens. It was suspected that the unbonded length used in many standards (˜500 mm.) was not representative of the situation in cracked concrete where a typical crack would be noticeable at about 0.5 mm and could grow for the case-of steel reinforcement to a width of about 50 mm. The various standard test specifications call for a minimum embedded length in the testing grips of approximately 250 mm in order to ensure re-bar tensile failure in the unbonded section and not shear failure in the grips.

Tensile testing of the prototype re-bar specimens showed two distinctive types of failures. Schematics based on longitudinal slitting of the failed prototype specimens after testing are shown in FIGS. 8a and 8b. The first type pertains to the first examples where the inner rod failed after sliding over a length with respect to the over-wrap. This is shown schematically in FIG. 8a. The frictional shear force provided by the interface in this case was gauged to be comparable to the tensile force capability of the inner rod. The second type of failure pertains to the second set of prototypes where the over-wrap had breaks in it, thus reducing the frictional shear force between the inner rod and the over-wrap in comparison to the inner rod tensile force capability. In these prototypes the inner rod did not break, it continued to slide out of the over-wrap until the test was stopped. This is shown schematically in FIG. 8b. The load-displacement plots showing the two types of prototype failures for gauge lengths of 50 mm (typical of a large crack width) and 0.5 mm (typical of a small crack

$${L}_{{c}_{o}} \leq \frac{{σ}_{ur} {r}_{r}}{{τ}_{r}} \qquad ( 7 )$$

width) are presented in FIGS. 9a and 9b respectively. All the plots exhibit jagged load variations associated with the inner rod sliding out of the over-wrap. This phenomenon is attributed to friction (dry or static friction) between the sliding surfaces.

In the example of a preferred embodiment illustrated in FIGS. 3a and 3b, then, the length L_{c}_{ₒ} of sections of over-wrap that are separated by serrations or other weakened sections will satisfy the equation:

The lengths of structurally complete sections of over-wrap can be separated by annular cuts, spiral cuts, chemical abrading, or any other means selected by one skilled in the art.

A preferred method of isolating structurally complete sections of over-wrap, eg. braided over-wrap, is shown in FIG. 3b. In the re-bar shown in FIG. 3b, the core 1 is made from a fibre/polymer matrix composite, and the over-wrap 2 is braided. However, at locations spaced apart by length L calculated as above, along the length of the core, the core is wrapped with polytetrafluoroethylene (Teflon) tape 11, so that there is no adhesion to the inner rod by the over-wrap at those spaced apart locations. Therefore, frictional shear stress at those locations will be essentially zero.

The pseudo-ductile performance of the FIG. 3a and FIG. 3b re-bar will be virtually identical. That is, local cracks in concrete will tend to cause original bond failure between the over-wrap and the inner-rod in discrete sections of over-wrap of length L adjacent the crack. At the spaced apart weakened locations 3/11, the over-wrap will break, but the inner-rod will remain intact. Increases in load at the crack site, eg. in the case of an earthquake, may cause further structurally discrete portions of over-wrap to debond from the core, in a pattern radiating away from the crack. Until complete failure, though, the re-bar will remain bonded to the concrete at regions away from the cracked region, and even after failure of the bond between the over-wrap and inner rod along the entire length of the inner rod will resist collapse because of the friction between the unbonded over-wrap and the inner rod.

As an example of a design case a high ductility 11.5 mm FRP re-bar with a single inner rod with a diameter of 9.5 mm and a 1 mm over-wrap, assume that the mechanical properties of the designed re-bar is required to match those of a standard steel re-bar (i.e. elastic modulus E=200 GPa, yield strength σ_{y}=600 MPa, and a very high local ductility at local cracks). The inner rod will be fabricated using carbon fibre in a matrix of typical epoxy resin (E=3.5 GPa, and (σₘ=100 MPa).

In order to determine the type of carbon fibre to use in order to achieve a re-bar with elastic modulus Eᵣ=200 GPa (matching that of steel), assume that there is no contribution to the elastic modulus from the over-wrap (typically less than 10%), and that the fibre volume fraction in the inner rod is between 50 and 65% (typical range for many unidirectional fibre composite components).

Since the elastic modulus in primarily a linear function of the elastic modulus times the fibre volume fraction, the range of elastic moduli of the fibres is E_{f}=300 to 400 GPa. For a typical carbon fibre of approximately E_{f}=300 GPa (Toryaca M30) the exact volume fraction including the contribution from the matrix is calculated using the- Rule of Mixtures method:

E_{c}=E_{f}V_{f}+Eₘ(1−V_{f}) (8)

Substituting for E_{c}, E_{f}, Eₘ in the above equation, the volume fraction of the fibre in the composite is found to be V_{f}=0.66.

Again, using the Rule of Mixtures method the tensile strength of the carbon fibre/epoxy re-bar can be obtained as follows:

σ_{c}=σ_{f}V_{f}+σ′ₘ(1−V_{f}) (9)

where σₘ′ is the matrix at fibre failure (˜100 MPa)

Substituting for of σ_{f}, σₘ′ and V_{f} in the above equation, the tensile strength of the FRP re-bar is found to be 2674 MPa, or approximately 4.5 times the design value of 600 MPa, thus it will not fail in tension prior to sliding at the interface.

An over-wrap length less than the critical length calculated using the following equation will result in shear failure (sliding against a frictional shear stress) at the interface between the inner FRP rod and the over-wrap. This mode of failure is the desired one, as compared to inner rod failure in tension.

$${L}_{{c}_{o}} = \frac{{σ}_{r}^{′} {r}_{r}}{{τ}_{r}} \qquad ( 10 )$$

In the above equation, τᵣ is found experimentally. For the materials, the manufacturing, and the curing methods used to produce the sample prototypes, τᵣ is found to be 9.6 MPa. Substituting this value and those for σᵣ and r, the critical length L_{c} is found to be 1.32 m.

A 9.5 mm diameter FRP rod with a pseudo-yield stress of σ_{y}=600 MPa should have a load carrying capacity (σ_{y}πᵣ²) of 42508 N within the elastic regime. Beyond that load, the rod should exhibit a ductile behaviour, in this case by the sliding of the over-wrap relative to the FRP inner rod. That is to say that the shear load between the FRP inner rod and the over-wrap should be able to withstand a tensile load of 42 508 N. This shear load is given by:

Shear load=2πrᵣlτᵣ

Substituting for the shear load, rᵣ, τᵣ in the above equation, gives an over-wrap length of l=0.15 m that can carry the shear load before shear failure between the over-wrap and the FRP inner rod takes place. This is less than the calculated critical length of L_{c}, so it will exhibit the desired pseudo-ductile behaviour.

Thus the high ductility rod will have discontinuity in the over-wrap with the over-wrap segments having lengths of 0.15 m each.

The second preferred embodiment of the present invention involves the use of aligned meso-rods, so called because of their intermediate size.

The initial work on this concept focussed on using model specimens in pullout tests. As in the previous concept, control of the interfacial frictional shear stress between the sliding surfaces is of utmost importance. In this case however, because of the size and number of the meso-rods, their homogeneity of size and surface consistency is paramount. As proof of concept, ground, and dimensionally accurate steel dowel pins were used. These were embedded in vacuumed epoxy resin. The resin was cured at room temperature for one day; a completed specimen is shown in FIG. 10a. Since the resin was relatively transparent it was also possible to confirm the fundamental concept of the approach in that the initial bond failure occurred at the ends of the meso-rod and then progressed towards its centre. Once the original bond had failed all along the length, one-half of the meso-rod started to pullout of the matrix socket against the frictional shear stress (FIG. 10b). The load-extension curves are shown in FIG. 11 for three specimens (specimens 2, 3, & 4). The frictional shear stress develops due to the contraction of the resin around the steel rods as a result of chemical shrinkage of the resin during polymerization. The results for the three specimens are very similar indicating good repeatability between casting runs. The results are also similar in nature to those obtained from the pull-out tests shown in FIG. 7. Also included in FIG. 11 is the curve for a specimen in which an elevated temperature epoxy resin (cure temperature 110 degrees C.) was used. It is clear that, as expected, additional frictional shear stress results from the resin thermally shrinking around the dowel pin. Other values of frictional shear stress can be obtained using other resin types and other cure schedules. Thus, it is possible to obtain the desired failure of frictional shear stress (the most critical parameter) for the application.

A full-size re-bar 4 incorporating meso-rods 5 consists of a number of fibre composite meso-rods (multiple meso-rods), staggered along the length of the re-bar, encapsulated in a second polymer matrix 6 as shown in FIGS. 4a and 4b. The individual meso-rods could also be continuous rods that are almost completely cut through. Two different ways to provide continuous rods that are almost cut through are shown in FIGS. 4c and 4d. The small amount of continuous fibre composite which can be located at any point in the cross-section aids in aligning the meso-rods along the axis of the re-bar during the manufacturing process. Tensile failure will occur at the reduced cross-section points at low values of tensile load. Due to the reduced elastic modulus magnitudes in discontinuous -fibre composites, it is desirable to have some continuous fibre composite material along the entire length of the re-bar. This may be provided by the continuous composite referred to previously.

The following is an example of a high ductility composite multiple meso-rod re-bar, 11.5 mm outside diameter, with properties similar to those described above in relation to FRP inner rod/over-wrap re-bar discussed in the previous embodiment, that is, an elastic modulus in the E=300 GPa range, yield strength in the τ=600 MPa range, and high local ductility.

The re-bar uses an epoxy matrix with an elastic modulus of E=3.5 GPa, the stress σₘ′ in the matrix at fibre failure being 100 MPa.

Since elastic modulus will be reduced due to the use of discontinuous meso-rods as compared to continuous meso-rods and elastic modulus increase with fibre volume fraction, a fibre volume fraction at the high end of the practical range for manufacturing will be chose, namely V_{f}=0.65. This is accomplished with 22 meso-rods, each of 2 mm diameter at any cross- section. Again, in order to maximise the elastic modulus of the individual meso-rods, a high modulus carbon fibre should be selected. For example, Torayca M40, with E_{f}=400 GPa and σ_{f}=700 MPa along with a high fibre volume fraction within the meso-rod, namely V_{f}=0.65.

Since the re-bar is to carry the same load (i.e., design capacity) as the inner rod with over-wrap concept, i.e. 42508 N, the required load capacity per meso-rod is 1932 N.

For a constant frictional shear stress, τᵣ, along the length of the meso-rod, the load in the meso-rod increases linearly from the end. For a load of 1932 N to be carried over one-half the length of the meso-rod, the load at mid-point of the meso-rod must be twice the average value, i.e., 3864 N.

The length of the meso-rod is calculated as follows:

$$\begin{matrix}3864 = 2 π {r}_{m} ( {l}_{m} / 2 ) {τ}_{m} \\ = 2 π ( 1 \times {10}^{- 3} ) ( {l}_{m} / 2 ) {τ}_{m} \\ {l}_{m} = 0.12 m\end{matrix}$$

Where τₘ was measured experimentally. Thus, 22 meso-rods of length 0.12 m are required to provide the load capability of 42,508 N.

In order to ascertain that individual meso-rods do not fail in tension before failing in shear, assume that the ultimate strength of meso-rod in tension:

$$\begin{matrix}{σ}_{c} = {σ}_{f} {V}_{f} + {σ}_{m}^{′} ( 1 - {V}_{f} ) \\ = ( 1700 \times {10}^{6} ) ( 0.65 ) + ( 100 \times {10}^{6} ) ( 1 - 0.65 ) \\ = 1140 MPa\end{matrix}$$

Load in meso-rod at ultimate strength:

$$\begin{matrix}L = {σ}_{c} ( {A}_{meso - rod} ) \\ = ( 1140 \times {10}^{6} ) ( π / 4 ) {( 2.0 \times {10}^{- 3} )}^{2} \\ = 3580 N\end{matrix}$$

### This is much larger than the load at which the interface sliding will take place, i.e., 1932 N, therefore, the meso-rods will not fail in tension prior to interfacial sliding.

Finally, the elastic modulus of the re-bar with multiple meso-rods can be calculated using an accepted formula (Halpin-Tsai) for the elastic modulus of discontinuous fibre composites. As noted above, the elastic modulus is a linear function of the elastic modulus times the volume, for each constituent. In the present case, with E=3.5 GPa for the epoxy (volume fraction of 35%) and E=400 GPa for Torayca M40 (volume fraction of 65%), the overall elastic modulus will be 216 GPa which is close to the desired value of 200 GPa. Exact values of elastic modulus can be achieved by altering the fibre volume fraction.

The pseudo-ductility concepts of re-bars proposed here can also be conceived through a number of alternate designs other than those shown in FIGS. 3 and 4. Any arrangement that provides for a controlled and gauged frictional shear stress between a medium anchored to the concrete and an inner rod that can sustain tensile loading would work. In the case of the arrangement shown in FIG. 3a the inner rod is anchored to the concrete by the braided over-wrap fibre bundles while braiding, using a different type of resin (whether thermoplastic or thermoset), or through surface preparation of the inner rod. In a similar manner, the control of the frictional shear load between the meso-rods and the surrounding matrix can be achieved by changing the material of the meso-rods, the surrounding matrix and its cure schedule, as well as by the surface preparation of the meso-rods.

For the case of the single FRP inner rod, the tensile force capability of the rod must be higher than the ultimate tensile force required, while the frictional shear force capability between that inner rod and the segments of the over-wrap must be gauged to be at the tensile load for the yield strength required. When the load at a section of the pseudo-ductile re-bar exceeds the yield load, sliding occurs, thus providing the pseudo-ductility effect. This is the case portrayed in FIG. 8b. If the frictional shear force capability between that rod and the segments of the over-wrap is close to the ultimate tensile force capability of the single inner rod, the case shown in FIG. 8a may occur.

The form of construction shown in FIGS. 3c, 3d and 3e provides an alternative pseudoductile re-bar that has a construction similar to that shown in FIG. 3a, and especially 3b, but performance characteristics similar to the product shown in FIG. 4a. In the FIGS. 3c, 3d and 3e product, an inner rod 1 similar to that shown in FIGS. 3a and 3b, typically a carbon fibre rod is textured, typically by the provision of a Kevlar over-wrap 2, and cured to provide a finished rod having desired elastic modulus and yield strength. The wrap, however, is not divided into structurally isolated sections. Rather, a further layer 12 of a material such as polyurethane foam, cardboard, or other sheet material is wrapped over the outer layer of the rod, dividing it into discrete sections that will adhere to a concrete matrix, where the Kevlar over-wrap is exposed, and other sections where there will be no bond between the sheet material over-wrap 12 and the Kevlar over-wrap 2. Accordingly, when the re-bar is subject to high frictional shear stress, there will be no inner rod failure or Kevlar over-wrap failure; rather, at a predetermined level of stress, the rod will tend to slide in the concrete—much like the sliding action of the meso rods in the FIG. 4a embodiment of the present invention.

As can be seen from FIGS. 3c and 3d, typically bands of predetermined width of sheet material are removed, either in the factory or on site, depending on the length of the re-bar, and the desired degree of yield strength. In order to make removal of the correct amount of sheet material simple at a job site, bands may be colour, number or letter coded, as shown in FIG. 3d. Alternatively, sheet material may be removed from the re-bar in lengthwise running strips, as shown in FIG. 3e. Where it is desired to have material removable at a job site, the material should be provided on its inner surface with an adhesive that can be peeled away fully so that the Kevlar over-wrap is not fouled. Also, the material should be perforated along lines 13 in predetermined patterns, to permit it to be peeled off easily.

Moreover, it will be appreciated that an effect similar to that obtained in the FIGS. 3c, 3d and 3d constructions may be obtained by selectively texturing a rod, by selectively sanding it in “patches” during fabrication, or by embossing a rod during fabrication in a predetermined pattern, eg. over only a half or a third of its circumferential area.

It should be emphasised at this point that while braiding was used to produce the over-wrap, other means can also be utilized. Wrapping of various types of strips on an existing inner rod is one such approach. Furthermore, while a serrated over-wrap was used to limit the interfacial frictional shear force at a segment of the inner rod, other means like a helical wrap would produce a similar effect.

The primary use of the reinforcing rod of the present invention will be in reinforcing concrete structures, where it will take the place of steel. Other uses will be obvious to one skilled in the art, and include reinforcement of mine tunnel and stope ceiling and walls, especially in corrosive environments, post tensioning of lightweight beams, fabrication of automotive and rolling stock chassis, airframes and the like. It will be understood, moreover, that the large majority of alternative uses relate to the structurally discontinuous meso-rod containing embodiments of the present invention, since they do not rely on adhesion between the outer surface of the rod and a surrounding environment to exhibit pseudo-ductility.

Moreover, it will be understood that the rod of the present invention need not be circular in cross-section. The present invention may be in the shape of other traditional structural elements, such as elliptical, I-shapes, T-shapes, L-shapes, U-shapes, box-shapes. It is also within the scope of the present invention to utilize structurally or functionally discontinuous meso-rods, for instance, in a particular zone of a structural element. For example, it is within the scope to the present invention to embed a plurality of structurally discontinuous meso-rods in the base of an extruded aluminum I-beam, thereby strengthening same, and providing a measure of pseudo-ductility to same.

Moreover, it will be understood that an additional application is in increasing the toughness of structures where toughness is measured as the work done (energy absorption) in separating two or more parts of a structure.

1. A re-bar (reinforcing rod) for concrete comprising an inner rod of a first material, and an over-wrap of a second material, said over-wrap being structurally or functionally discontinuous relative to said inner rod.

2. A reinforcing rod as claimed in claim 1, wherein said inner rod comprises a rod made from a material consisting of a polymeric material or a polymeric matrix and reinforcing fibre.

3. A reinforcing rod as claimed in claim 1, wherein said over-wrap is a polymeric material or a fibrous material set in a polymeric matrix.

4. A reinforcing rod as claimed in claim 3, wherein said fibrous material is selected from the group consisting of ceramic materials including carbon and glass fibres, polymeric materials such as aramid and polyethylene, and metallic materials like steel.

5. A reinforcing rod as claimed in claim 4, wherein said resin is selected from the group consisting of thermoset resins such as epoxies, polyesters, and vinyl esters, and thermoplastic resins such as nylon, polyethylene, and polypropylene.

6. A reinforcing rod as claimed in claim 3, wherein said over-wrap includes zones of weakness separating full strength lengths of said outer layers.

7. A reinforcing rod as claimed in claim 3, wherein said over-wrap includes zones of low frictional shear stress between the over-wrap and the inner rod interspersed among high frictional shear stress zones.

8. A reinforcing rod as claimed in claim 7 wherein said low frictional shear stress zones are achieved by application of a layer of low friction material on said inner rod at said zones of low frictional shear stress, and said over-wrap covers said low frictional material.

9. A reinforcing rod as claimed in claim 6 wherein said zones of weakness are formed by mechanically removing a portion of said over-wrap after it has been applied to said inner rod.

10. A reinforcing rod as claimed in claim 6, wherein said zones of weakness are defined by short spaced apart lengths of said inner rod having no outer-wrap over same.

11. A reinforcing rod as claimed in claim 6 wherein said zones of weakness are defined by local shearing of polymer over-wrap.

12. A reinforcing rod as claimed in claim 1, wherein said inner rod is a cylindrical rod having radius rᵣ and an ultimate tensile strength σᵤᵣ, the frictional shear stress after bond failure between the inner rod and the over-wrap is τᵣ, and said over-wrap is comprised of structurally discontinuous portions having a maximum length L_{c}_{ₒ}, wherein
$${L}_{{c}_{o}} = \frac{{σ}_{ur} {r}_{r}}{{τ}_{r}}$$

13. A rod as claimed in claim 12, wherein said radius r is in the range of 1-30 mm.

14. A rod as claimed in claim 12, wherein said length L_{c}_{ₒ} is in the range of 1-150 cm.

15. A rod as claimed in claim 13, wherein said radius r is in the range of 3-8 mm.

16. A rod as claimed in claim 15, wherein said radius r is in the range of 4-6 mm.

17. A rod as claimed in claim 16, wherein said radius r is in the range of 4-5 mm.

18. A rod as claimed in claim 17, wherein said radius r is 4.5 mm.

19. A rod as claimed in claim 13, wherein said length L is in the range of 10-20 cm.

20. A rod as claimed in claim 19, wherein said length L is in the range of 12-18 cm.

21. A rod as claimed in 20, wherein said length L is about 15 cm.

22. A method of inducing pseudo-ductility or toughness in a fibre reinforced composite rod, said rod comprising a solid core and a fibre reinforced polymeric resin over-wrap on said core, said method comprising structurally interrupting said over-wrap at spaced apart locations.

23. A method as claimed in claim 22, wherein said over-wrap is applied as a resin impregnated fibre braid.

24. A method as claimed in claim 22, wherein said over-wrap is applied as a resin impregnated fibre yarn, unidirectional tape or woven fabric tape helically wound on said core.

25. A method as claimed in claim 22, wherein said over-wrap is structurally interrupted by being cut in spaced apart annular rings.

26. A method as claimed in claim 22, wherein said over-wrap is structurally interrupted by being cut in a continuous helical pattern.

27. A method as claimed in claim 22, comprising the steps of
i) providing an inner rod comprising solid core a fibre reinforced polymer
ii) applying bands of material having low frictional shear stress at spaced apart locations on said solid core
iii) applying a fibre reinforced polymeric resin over-wrap over the banded core, whereby said bands of low frictional shear stress material structurally separate zones of over-wrap bonded to said core.

28. A method as claimed in claim 22, wherein said solid core is a cylindrical rod having radius rᵣ and an ultimate tensile strength σᵤᵣ, the frictional shear stress after bond failure between the solid core and the over-wrap is τᵣ, and said over-wrap is comprised of structurally discontinuous portions having a maximum length L_{c}_{ₒ}, wherein
$${L}_{{c}_{o}} = \frac{{σ}_{ur} {r}_{r}}{{τ}_{r}}$$

29. A method as claimed in claim 28, wherein said radius r is in the range of 1-30 mm.

30. A method as claimed in claim 28, wherein said length L_{c}_{ₒ} is in the range of 1-150 cm.

31. A method as claimed in claim 29, wherein said radius r is in the range of 3-8 mm.

32. A method as claimed in claim 31, wherein said radius r is in the range of 4 -6 mm.

33. A method as claimed in claim 32, wherein said radius r is in the range of 4 -5 mm.

34. A method as claimed in claim 33, wherein said radius r is 4.5 mm.

35. A method as claimed in claim 29, wherein said length L is in the range of 10-20 cm.

36. A method as claimed in claim 35, wherein said length L is in the range of 12-18 cm.

37. A method as claimed in 36, wherein said length L is about 15 cm.

38. A reinforcing rod comprising a composite of at least two materials, at least one of which is present in structurally discontinuous lengths.

39. A reinforcing rod as claimed in claim 38, comprising at least three materials, at least one of which is present in structurally or functionally discontinuous lengths.

40. A reinforcing rod as claimed in claim 38, wherein said composite comprises a polymer matrix having embedded therein structurally discrete meso-rods of length L_{c}_{ₒ} with radius rₘ, ultimate and tensile strength σᵤₘ, the frictional shear stress between a meso-rod and the polymer matrix being represented by τₘ, wherein
$${L}_{{c}_{m}} = \frac{{σ}_{um} {r}_{m}}{{τ}_{m}}$$

41. A reinforcing rod as claimed in claim 40, wherein said structurally discrete meso-rods comprise a plurality of aligned meso-rods that are, axially, substantially randomly distributed.

42. A reinforcing rod as claimed in claim 40, wherein said structurally discrete meso-rods comprise a plurality of elongated meso-rods breakable by a tensile load substantially less than the ultimate tensile load of each meso-rod, at predetermined weakened locations that are randomly staggered, from rod to rod.

43. A reinforcing rod as claimed in claim 40, wherein L_{c}_{ₒ} is in the range of 5-30 cm.

44. A reinforcing rod as claimed in claim 43, wherein L_{c}_{ₒ} is in the range of 5-25 cm.

45. A reinforcing rod as claimed in claim 43, wherein L_{c}_{ₒ} is in the range of 8-20 cm.

46. A reinforcing rod as claimed in claim 43, wherein L_{c}_{ₒ} is in the range of 10-15 cm.

47. A reinforcing rod as claimed in claim 43, wherein L_{c}_{ₒ} in the range of 11-13 cm.

48. A reinforcing rod as claimed in claim 43, wherein L_{c}_{ₒ} is optimally about 12 cm.

49. A reinforcing rod as claimed in claim 43, wherein rₘ is in the range of 0.5-4.0 mm.

50. A reinforcing rod as claimed in claim 43, wherein rₘ is in the range of 0.5-3.0 mm.

51. A reinforcing rod as claimed in claim 43, wherein rₘ is in the range of 1.0-3.0 mm.

52. A reinforcing rod as claimed in claim 43, wherein rₘ is in the range of 1.5-2.5 mm.

53. A reinforcing rod as claimed in claim 43, wherein rₘ is about 2.0 mm.

54. A reinforcing rod as claimed in claim 40, wherein said meso-rods are made from a material selected from the group consisting of ceramic materials including carbon fibres and glass fibres.

55. A reinforcing rod as claimed in claim 54, wherein said polymer matrix is selected from the group consisting of thermoset resins including epoxies, polyesters, and vinyl esters, and thermoplastic resins including nylons, polyethylene, and polypropylene.

56. A structural rod comprising a composite of at least two materials, at least one of which is present in structurally discontinuous lengths.

57. A structural rod as claimed in claim 56, comprising at least three materials, at least one of which is present in structurally or functionally discontinuous lengths.

58. A structural rod as claimed in claim 56, wherein said composite comprises a polymer matrix having embedded therein structurally discrete meso-rods of length L_{c}_{ₒ} with radius rₘ, ultimate and tensile strength σᵤₘ, the frictional shear stress between a meso-rod and the polymer matrix being represented by τₘ, wherein
$${L}_{{c}_{m}} \leq \frac{{σ}_{um} {r}_{m}}{{τ}_{m}}$$

59. A structural rod as claimed in claim 58, wherein said structurally discrete meso-rods comprise a plurality of aligned meso-rods that are, axially, substantially randomly distributed.

60. A structural rod as claimed in claim 58, wherein said structurally discrete meso-rods comprise a plurality of elongated meso-rods breakable by a tensile load substantially less than the ultimate tensile load of each meso-rod, at predetermined weakened locations that are randomly staggered, from rod to rod.

61. A structural rod as claimed in claim 58, wherein L_{c}_{ₒ} is in the range of 5-30 cm.

62. A structural rod as claimed in claim 61, wherein L_{c}_{ₒ} is in the range of 5-25 cm.

63. A structural rod as claimed in claim 61, wherein L_{c}_{ₒ} is in the range of 8-20 cm.

64. A structural rod as claimed in claim 61, wherein L_{c}_{ₒ} is in the range of 10-15 cm.

65. A structural rod as claimed in claim 61, wherein L_{c}_{ₒ} is in the range of 11-13 cm.

66. A structural rod as claimed in claim 61, wherein L_{c}_{ₒ} is in the range of 12 cm.

67. A structural rod as claimed in claim 61, wherein rₘ is in the range of 0.5-4.0 mm.

68. A structural rod as claimed in claim 61, wherein rₘ is in the range of 0.5-3.0 mm.

69. A structural rod as claimed in claim 61, wherein rₘ is in the range of 1.0-3.0 mm.

70. A structural rod as claimed in claim 61, wherein rₘ is in the range of 1.5-2.5 mm.

71. A structural rod as claimed in claim 61, wherein rₘ is about 2.0 mm.

72. A structural rod as claimed in claim 58, wherein said meso-rods are made from a material selected from the group consisting of ceramic materials including carbon fibres and glass fibres.

73. A structural rod as claimed in claim 72, wherein said polymer matrix is selected from the group consisting of thermoset resins including epoxies, polyesters, and vinyl esters, and thermoplastic resins including nylons, polyethylene, and polypropylene.

74. A reinforcing or structural rod as claimed in claim 38, having a cross-section that is of a shape selected from the group consisting of circular, elliptical, oval, square, rectangular, triangular, diamond shapes, dog-bone shaped, L-shaped, T-shaped, U-shaped, and 5-20 sided polygon shaped.

75. A method of inducing toughness in a structural element, comprising embedding in said structural element a plurality of structurally or functionally discrete meso-rods.

76. A reinforcing rod comprising a composite rod having an inner core and an outer surface, said outer surface being textured over a predetermined portion thereof to mechanically grip a concrete matrix in which a said rod is embedded.

77. A rod as claimed in claim 76, wherein said entire outer surface is textured, and portions thereof are masked from contact with a said concrete matrix by the provision of a sheet material thereon.

78. A rod as claimed in claim 77, wherein said sheet material is provided over said entire outer surface, and is selectively removable.

79. A rod as claimed in claim 78, wherein said sheet material is provided with circumferential bands of perforations, to permit portions thereof to be removed without damaging other portions thereof.

80. A rod as claimed in claim 78, wherein said sheet material is provided in longitudinally extending strips separated by longitudinal lines of perforations to permit selected strips to be removed without damaging others.

81. A rod as claimed in claim 79, wherein said sheet material is provided with indicia thereon to assist in the identification of portions to be removed.

82. A rod as claimed in claim 76, wherein said outer surface is textured by the provision of a textured outer wrap.

83. A rod as claimed in claim 82, wherein said outer wrap is a polyaramide Kevlar™ outer wrap.
